(19) United States
(12) Patent Application Publication
(10) Pub. No.: US 2026/0098565 A1
(43) Pub. Date: Apr. 9, 2026

(54) METAL BELLOWS COUPLING

(71) Applicant: COMPOMAC S.P.A., CASTEL MAGGIORE (IT)

(72) Inventors: Alessandro Marella, CASTEL MAGGIORE (IT); Arduino Bondi, CASTEL MAGGIORE (IT)

(21) Appl. No.: 19/348,523

(22) Filed: Oct. 2, 2025

(30) Foreign Application Priority Data
Oct. 3, 2024 (IT) 102024000021942

(51) Int. Cl. F16D 3/72; F16D 3/10

(52) U.S. Cl. CPC F16D 3/72; F16D 3/10; F16D 2250/0023; F16D 2250/0069; F16D 2250/0084; F16D 2300/12

(57) ABSTRACT

A metal bellows coupling comprises a first hub, a second hub and a bellows, which is interposed between the first hub and the second hub; the bellows comprises a tubular body having a longitudinal axis and axially delimited by a first end and a second end; the bellows is made of a metal material and has an intermediate portion, which is interposed between the first end and the second end; the intermediate portion of the bellows has a plurality of folds; each end of the bellows has a mating surface, which is configured to come in contact, in use, with a respective hub; the mating surface is at least partially knurled, defining a first knurling.

### CROSS-REFERENCE TO RELATED APPLICATIONS

This patent application claims priority from Italian patent application no. 102024000021942 filed on Oct. 3, 2024, the entire disclosure of which is incorporated herein by reference.

### TECHNICAL FIELD

The invention relates to a metal bellows coupling and to a method for assembling a metal bellows coupling.

### PRIOR ART

As it is known, couplings are mechanical members configured to connect two rotating components (for example, two shafts) to each other, so as to guarantee the transmission of torque from one rotating component to the other.

In detail, torsionally rigid joints are particularly suitable for industrial applications where high positioning precision is required.

Among torsionally rigid joints, the metal bellows joint is known. In general, a metal bellows coupling comprises a thin-walled stainless steel spring also identified, as a matter of fact, with the name bellows.

The metal bellows generally optimally compensates for axial, radial and angular displacements. At the same time, its geometric shape allows for a high torsional rigidity and a low moment of inertia of mass.

In general, the bellows is interposed between two hubs (or flanges), to which the two shafts are locked.

Currently, coupling to make a hub integral to a bellows in order to create a joint and transmit a torque is done by interposing a thin layer of glue between the parts.

Normally, hubs are machined with a roughness that allows the glue to grip the machined surface. The surfaces of the elastic elements (bellows), which are coupled to the hubs, usually undergo a brushing operation to increase their surface roughness.

The aforementioned processes give overall good results, however, sometimes it can happen that, especially on the bellows, the glue does not manage to have a good grip due to an insufficient roughness, with a consequent detachment between the hub and the bellows.

This condition can occur because the roughness parameters of the hubs and the brushing of the elastic elements (bellows) can have too wide tolerance ranges.

Some solutions are known that provide for narrower tolerance ranges in terms of roughness parameters of the components or for a different type of constraint between the hub and the bellows, for example with threaded members or (plasma) welds.

However, the aforesaid solutions require further machining, sometimes high-precision machining, which leads to a significant increase in production costs. This problem is particularly widespread, since joints of this type are components that usually provide relatively good performance at low costs.

Therefore, there is a need to provide a metal bellows coupling that does not suffer from the problems discussed above.

### DESCRIPTION OF THE INVENTION

Therefore, the object of the invention is to fulfil the needs discussed above in a simple, effective and economic fashion.

The aforesaid object is reached by a metal bellows coupling as defined in claim 1.

The dependent claims define special embodiments of the invention.

### BRIEF DESCRIPTION OF THE DRAWINGS

The invention will be best understood upon perusal of the following description of preferred embodiments, which is provided by mere way of non-limiting example and with reference to the accompanying drawings, wherein:

FIG. 1 shows a perspective view of a metal bellows coupling according to the invention;

FIG. 2 is a sectional view of the coupling of FIG. 1, with parts removed for greater clarity;

FIG. 3 shows an exploded side view of the coupling of FIG. 2;

FIGS. 4 and 5 are detailed views of the mating surfaces of two components of the coupling of FIG. 3; and

FIG. 6 shows two detailed views of the mating surfaces of FIGS. 4 and 5, when the coupling is assembled.

### EMBODIMENTS OF THE INVENTION

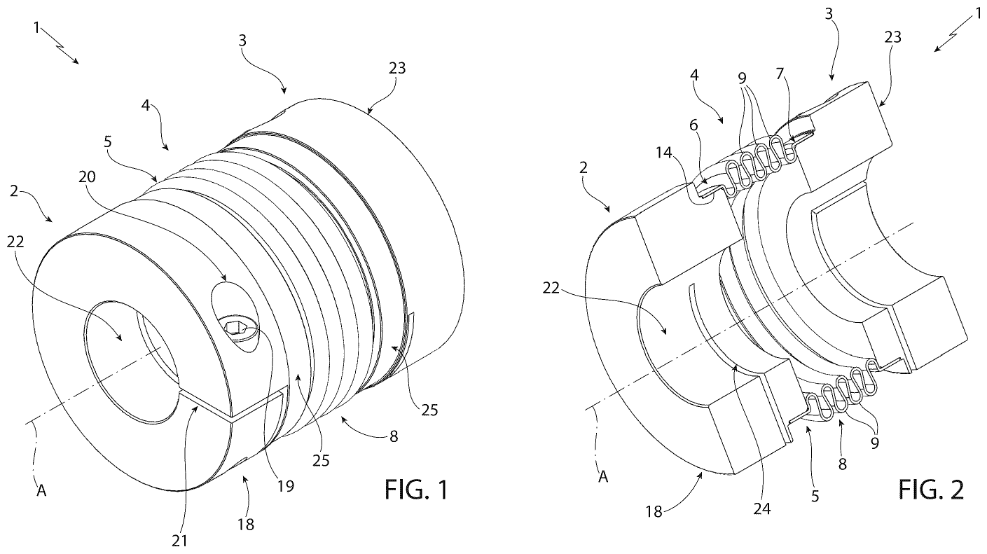

In FIG. 1, reference number 1 indicates, as a whole, a metal bellows coupling.

In the figures, the same numbers and the same reference letters indicate the same elements or components with the same function.

For the purposes of the invention, the term “second” component does not imply the presence of a “first” component. As a matter of fact, these terms are only used as labels to improve clarity and should not be interpreted in a limiting manner.

The elements and features contained in the different preferred embodiments, drawings included, can be combined with one another, without for this reason going beyond the scope of protection of this patent application, as described hereinafter.

The metal bellows coupling 1 comprises a first hub 2, a second hub 3 and a bellows 4, which is interposed between the first hub 2 and the second hub 3.

As shown in FIGS. 1 and 2, the bellows 4 comprises a tubular body 5 having a longitudinal axis A and axially delimited by a first end 6 and a second end 7.

The bellows 4 is made of a metal material and has an intermediate portion 8, which is interposed between the first end 6 and the second end 7.

According to the embodiment described herein, the bellows 4 is made of stainless steel.

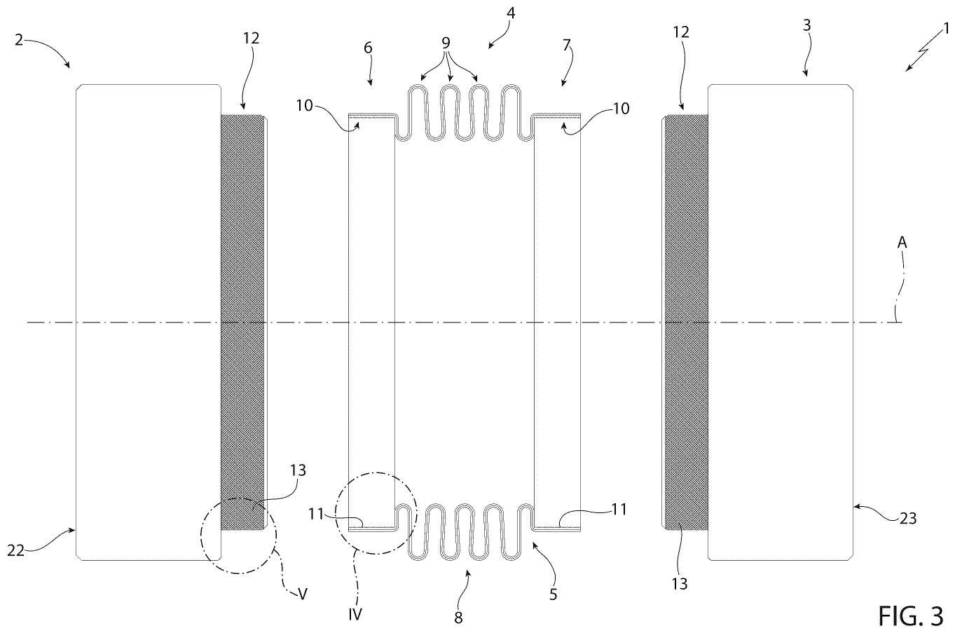

As shown in FIGS. 2 and 3, the intermediate portion 8 of the bellows 4 has a plurality of folds 9. In particular, the bellows 4 is a thin-walled stainless steel spring.

The metal bellows coupling 1 is torsionally rigid and is suitable for the clearance-free interconnection of two shafts, even if they are not exactly aligned with one another, for the transmission of torque. The “pleated” conformation (also called “harmonica”) of the bellows 4 generally optimally compensates for axial, radial and angular displacements.

With reference to FIG. 3, each end 6, 7 of the bellows 4 has a first mating surface 10, which is configured to come in contact, in use, with a respective hub 2, 3.

The first mating surface 10 is at least partially knurled, thus defining a first knurling 11. In other words, the knurling 11 covers at least a portion of the first mating surface 10.

In particular, “knurling” means a surface machining that creates a relief pattern of grooves or protrusions on a surface, for example the mating surface 10.

Preferably, each hub 2, 3 is configured to be fitted onto a respective end 6, 7 of the bellows 4. In this way, the coupling 1 is assembled and can be used for the connection of shafts or other components for the transmission of torque.

Furthermore, each hub 2,3 has a second mating surface 12, which is configured to come in contact, in use, with a respective end 6, 7 of the bellows 4.

The second mating surface 12 is at least partially knurled, thus defining a second knurling 13. In other words, the knurling 13 covers at least a portion of the second surface 12.

Advantageously, according to the embodiment shown herein, both the first mating surface 10 and the second mating surface 12 are at least partially knurled.

Preferably, the coupling 1 comprises an adhesive substrate 14, which is interposed between the first mating surface 10 and the respective second mating surface 12.

As better shown in FIG. 6, the adhesive substrate 14 is located between the mating surface 10 and the mating surface 12, in particular in contact with both mating surfaces 10, 12. In this way, the adhesive substrate 14 helps improve the stability of the coupling between the bellows 4 and the hub 2, 3 and the efficiency in the transmission of the torque.

The adhesive substrate 14 preferably comprises a locking adhesive (glue), for example a Loxeal® or LOCTITE® specifically indicated the of adhesive for locking components designed to transmit torque. Depending on the adhesive used, there are different thicknesses of the substrate 14 and different methods of applying the adhesive itself. These technical details are usually indicated in the technical data sheets of the supplier and, therefore, are not discussed herein.

In particular, the coupling 1 comprises a containment ring 25, shown in FIG. 1, for the containment of any adhesive leaks during gluing. More in particular, the coupling 1 comprises two containment rings 25, one for each end 6,7 of the bellows 4 coupled to the respective hub 2, 3. According to the example shown herein, the ring 25 is made of aluminium.

Preferably, the first end 6 and the second end 7 of the bellows 4 have the shape of a first hollow cylinder and the first mating surface 10 is an outer lateral surface of said first hollow cylinder. Furthermore, the first hub 2 and the second hub 3 have the shape of a second hollow cylinder and the second mating surface 12 is an inner lateral surface of said second hollow cylinder.

According to the non-limiting embodiment shown in the accompanying figures, the first knurling 11 and the second knurling 13 extend over the entirety of the first mating surface 10 and the second mating surface 12, respectively.

In other words, the first knurling 11 and the second knurling 13 extend over the mating diameter of the bellows 4 and the hub 2, 3. In this way, thanks to a greater extension of the knurled area, the grip of the adhesive layer 14 can be increased.

Preferably, the first knurling 11 and/or the second knurling 13 define geometric patterns, in particular defining polygons, preferably quadrilaterals, in detail squares.

Preferably, the first knurling 11 and the second knurling 13 comprise a first set of linear grooves (incisions) 15 inclined with respect to the longitudinal axis A and parallel to each other. The first set of grooves 15 is inclined at an angle α with respect to the longitudinal axis A.

Preferably, the first knurling 11 and the second knurling 13 comprise a second set of linear grooves 15 inclined at an angle β with respect to the longitudinal axis A and parallel to each other.

In particular, the angle β is different from the angle α. More in particular, the angle β is equal and opposite to the inclination angle α of the first set of grooves 15.

Preferably, the angle α is 45° and the angle β is −45°.

Advantageously, the first set of grooves 15 and the second set of grooves 15 are crossed with each other in a checkerboard pattern.

In particular, according to the drawings, the first and the second set comprise grooves 15 that are equally distant from each other and, given their inclination, the pattern resulting from their intersection is a grid of squares.

According to other embodiments that are not shown herein, the angle α is 0° and the angle β is 90°. In other words, the grid of squares has sides that are parallel and perpendicular to the longitudinal axis A.

According to other embodiments that are not shown herein, the first knurling 11 and the second knurling 13 only comprise the first set of grooves 15, which are parallel to the longitudinal axis A. In other words, the angle α is 0°. Preferably, the first knurling 11 and the second knurling 13 are obtained by plastic deformation process. A process of this kind increases the strength of the material, unlike a typical chipping machining. In particular, by deforming the material (metal) under cold conditions, as a result of the force exerted upon the piece, the metal is “shifted”, forming depressions (grooves) and cusps (ridges) on the surface.

Preferably, following the described machining, the first knurling 11 and the second knurling 13 therefore comprise a series of cusps 16 and a series of depressions 17.

Therefore, the adhesive of the substrate 14 can be deposited in the depressions 17 and is held inside them by the cusps 16, thus making the grip between the adhesive substrate 14 and the parts that must be coupled, namely the bellows 4 and the hub 2, 3, stronger. In other words, the adhesive substrate 14 penetrates the depressions 17 and is countered by the cusps 16, hence achieving the coupling between the parts. By so doing, torque is transmitted between the parts in a positive manner.

In particular, the presence of the adhesive substrate 14 improves the coupling, since most of the torque is transmitted through it, thanks to the mechanical characteristics of the adhesive, exploiting the relationship (interaction) with the cusps 16 and the depressions 17 of the knurls 11 and 13.

Preferably, the first knurling 11 and the second knurling 13 are obtained by knurling by roll forming.

Roll forming (sometimes also called knurling) is a plastic deformation process carried out using a specific tool, the knurling roll, which simply cuts thin lines into the workpiece, without removing chips. Knurling by roll forming is generally carried out on the lathe and uses knurling profiles defined by regulations (UNI 149 DIN 82).

Advantageously, therefore, the machining carried out on the hubs 2, 3 and on the bellows 4 are performed with equipment with defined and constant parameters, which can be easily verified.

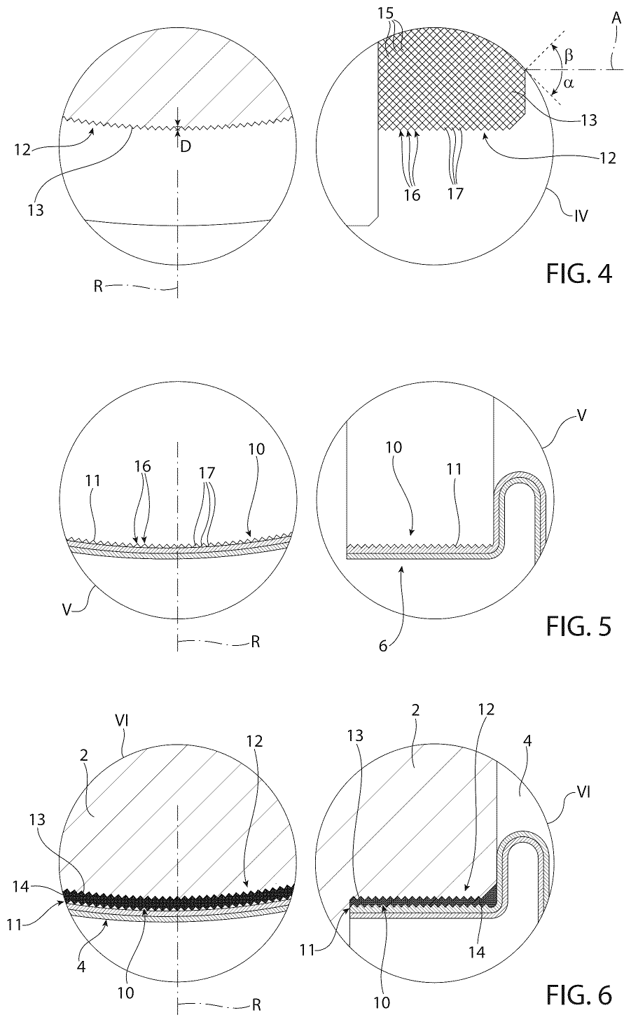

FIGS. 4 and 5 show two details (IV, V) of FIG. 3. In particular, a front and a side view of the hub 2 and the bellows 4, respectively, are enlarged. It can be seen that the depressions 17 and the cusps 16 are present in both the views provided. In particular, in the example shown, a same pattern is used for both knurls 11, 13. According to some variants, the patterns used in the knurlings 11, 13 are different from each other.

Furthermore, as shown in the detail views (VI) of FIG. 6, when the hub 2 and the bellows 4 are coupled to each other in the area of the mating surfaces 10, 12, there is (by design) a gap, which is filled by the adhesive substrate 14.

Preferably, but not limited to, with reference to FIG. 4, the distance between the cusps 16 and the depressions 17 along a radial direction R with respect to the longitudinal axis A of the bellows 4 is smaller than or equal to 10 mm and greater than or equal to 0.01 mm.

In particular, in the example shown, the distance between the cusps 16 and the depressions 17 is 0.4 mm.

In use, the coupling 1 is used to connect two shafts (not shown) to each other. For example, a first driving shaft is connected to the first hub 2, in the area of a connecting portion 22 of the hub 2, and a second driven shaft is connected to the second hub 3, in the area of a connecting portion 23 of the hub 3.

In particular, according to the embodiment shown, the hubs 2, 3 comprise a clamp connection 18 for locking the shafts. In the non-limiting example shown, the hubs 2, 3 are made of aluminium. According to some variants, the hubs are made of steel.

The clamp connection 18 is obtained by tightening a screw 19 in a hole 20 made in the connecting portion 22, 23 of the hub 2, 3, which is suitably shaped to deform when the screw 19 is tightened and to clamp the shaft portion housed therein, so as to obtain a stable shaft/hub connection. In particular, for this purpose, in the example shown, the portion 22, 23 has a cut 21 along the radial direction R and a cut 24 on a section plane of the hub 2.

In general, the coupling between the shaft and the hub is any known coupling designed to guarantee the transmission of torque, and, therefore, is not described in detail.

During torque transmission, the coupling conditions between the hubs 2, 3 and the bellows 4 determine the torque transmitted between the driving part and driven part (the two shafts that are not shown). The presence of the knurlings 11, 13 means that the adhesive substrate 14 can optimally adhere to the mating surfaces 10, 12, exerting all the necessary resistance to transmit the maximum torque of the coupling 1 with a suitable safety margin.

According to the invention, there is also provided a method for assembling a metal bellows coupling according to the following description.

Preferably, though not in a limiting manner, the aforementioned method is used to assemble the metal bellows coupling 1 described above.

The method comprises (at least) the steps of:
knurling at least part of the first mating surface 10;
coupling the first end 6 and the second end 7 of the bellows 4 to the respective hub 2, 3 along the longitudinal axis A, so that the first mating surface 10 comes in contact with the respective hub 2, 3.

Preferably, the method comprises, prior to the coupling step, the further step of knurling at least part of the second mating surface 12.

Preferably, the method comprises, prior to the coupling step, the further steps of:
degreasing the first mating surface 10 and the second mating surface 10;
interposing an adhesive substrate 14 between the first mating surface 10 and the second mating surface 12; and
polymerizing the adhesive substrate 14.

As described above, as far as the application of the adhesive substrate 14 is concerned, the supplier's instructions are followed. The polymerization process also is generally indicated in the product data sheet. For example, the polymerization is carried out by means of heat (in the oven) or at room temperature, depending on the type of adhesive.

Preferably, geometric patterns are obtained during the knurling step and the further knurling step.

Preferably, during the knurling step and the further knurling step, a first knurling 11 and a second knurling 13 are made, respectively, which comprise a first set of linear grooves 15 inclined with respect to the longitudinal axis A and parallel to each other.

Preferably, the knurling step and/or the further knurling step are carried out by knurling by roll forming.

The metal bellows coupling and the assembling method described above have many advantages.

In particular, thanks to the presence of the knurlings 11, 13, the adhesive substrate 14 has a good grip on the mating surfaces 10, 12, keeping the coupling between the hub 2, 3 and the bellows 4 stable, in use. Consequently, the presence of the knurlings 11, 13 allows for a good transmission of torque between two shafts, a driving shaft and a driven shaft, connected to each other by means of the coupling 1.

Furthermore, since the machining of the hubs 2, 3 and of the bellows 4 is carried out with equipment with defined and constant parameters, it is easily verifiable and makes the coupling between the adhesive substrate 14, the bellows 4 and the hub 2, 3 safer and cheaper.

In practice, the coupling 1 disclosed herein offers high coupling precision and safety, namely good performances, at low production costs, compared to known solutions.

Further advantages are evident for a person skilled in the art based on the information disclosed above.

Furthermore, it is evident that the solution shown herein is versatile, namely suitable for other metal bellows or torsionally rigid joints.

Finally, the metal bellows coupling 1 according to the invention can be subjected to changes and variants, which, though, do not go beyond the scope of protection set forth in the appended claims.

For example, the bellows 4 can have a different shape or be made of a different metal; moreover, the angles of inclination of the grooves 15 and the knurling patterns can change.

1. A metal bellows coupling comprising a first hub, a second hub and a bellows, which is interposed between the first hub and the second hub; in which the bellows comprises a tubular body presenting a longitudinal axis bounded axially by a first end and a second end; the bellows is made of metallic material and has an intermediate portion that is interposed between the first end and the second end; wherein the intermediate portion of the bellows has a plurality of folds; wherein each end of said bellows has a first mating surface that is configured to come in contact, in use, with a respective hub; wherein said first mating surface is at least partially knurled, defining a first knurling.

2. The metal bellows coupling according to claim 1, wherein each hub is configured to be fitted on a respective end of said bellows; wherein each hub has a second mating surface that is configured to come in contact, in use, with a respective end of said bellows; wherein said second mating surface is at least partially knurled, defining a second knurling.

3. The metal bellows coupling according to claim 2 and comprising an adhesive substrate that is interposed between a first mating surface and a respective second mating surface.

4. The metal bellows coupling according to claim 2, wherein
the first end and the second end of the bellows have the shape of a first hollow cylinder and the first mating surface is an outer side surface of said first hollow cylinder;
the first hub and the second hub have the shape of a second hollow cylinder, and the second mating surface is an inner lateral surface of said second hollow cylinder; and
the first knurling and the second knurling extend over the entirety of the first mating surface and the second mating surface.

5. The metal bellows coupling according to claim 2, wherein the first knurling and the second knurling define geometric patterns.

6. The metal bellows coupling according to claim 2, wherein the first knurling and the second knurling comprise a first set of linear grooves inclined with respect to the longitudinal axis and parallel to each other.

7. The metal bellows coupling according to claim 6, wherein the first set of grooves is inclined 45° with respect to the longitudinal axis, and the first knurling and the second knurling comprise a second set of linear grooves inclined −45° with respect to the longitudinal axis and parallel to each other; wherein the first set of grooves and the second set of grooves are crossed with each other in a checkerboard pattern.

8. The metal bellows coupling according to claim 2, wherein the first knurling and the second knurling are obtained by plastic deformation process.

9. The metal bellows coupling according to claim 8, wherein the first knurling and the second knurling are obtained by knurling by roll forming.

10. The metal bellows coupling according to claim 2, wherein the first knurling and the second knurling comprise a series of cusps and a series of depressions, wherein the distance between the cusps and the depressions along a direction radial to the longitudinal axis of the bellows is less than or equal to 10 mm and greater than or equal to 0.05 mm.

11. A method for assembling a metal bellows coupling comprising a first hub, a second hub, and a bellows, which is interposed between the first hub and the second hub; wherein the bellows comprises a tubular body presenting a longitudinal axis bounded axially by a first end and a second end; wherein the bellows is made of a metallic material and has an intermediate portion which is interposed between the first end and the second end; wherein the intermediate portion of the bellows has a plurality of folds; wherein each end of said bellows has a first mating surface which is configured to come in contact, in use, with a respective hub;
the method comprises the steps of: [symbol]
knurling at least part of the first mating surface; [symbol]
coupling the first end and the second end of the bellows to the respective hub along the longitudinal axis, so that the first mating surface comes in contact with the respective hub.

12. The method according to claim 11, wherein each hub is configured to be fitted on a respective end of said bellows; wherein each hub has a second coupling surface that is configured to come in contact, in use, with a respective end of said bellows;
the method comprising, prior to the step of coupling, the further step of knurling at least part of the second mating surface.

13. The method according to claim 12 and comprising, prior to the step of coupling, the further steps of: [symbol]
degreasing the first mating surface and the second mating surface; [symbol]
interposing a substrate of adhesive between the first mating surface and the second mating surface; and [symbol]
polymerizing the substrate of adhesive.

14. The method according to claim 12, wherein geometric patterns are obtained during the knurling step and the further knurling step.

15. The method according to claim 12, wherein, during the knurling step and the further knurling step, a first knurling and a second knurling are made, respectively, which comprise a first set of linear grooves inclined with respect to the longitudinal axis and parallel to each other.

16. The method according to claim 12, wherein the knurling step and/or the further knurling step are carried out by knurling by roll forming.
